(19) United States
(12) Patent Application Publication
(10) Pub. No.: US 2024/0383576 A1
(43) Pub. Date: Nov. 21, 2024

(54) MOORING LINE FOR FLOATING PLATFORM

(71) Applicants: TECHLAM, CERNAY (FR); TotalEnergies One Tech, COURBEVOIE (FR)

(72) Inventors: Stéphane LE-GUENNEC, BOUGIVAL (FR); Joël LIBOLT, CERNAY (FR); Alain SKRABER, BERRWILLER (FR)

(73) Assignees: TECHLAM, CERNAY (FR); TotalEnergies One Tech, COURBEVOIE (FR)

(21) Appl. No.: 18/694,531

(22) PCT Filed: Sep. 23, 2022
(86) PCT No.: PCT/EP2022/076549

§ 371 Date: Mar. 22, 2024

(30) Foreign Application Priority Data
Sep. 24, 2021 (EP) 21306304.1

(51) Int. Cl. B63B 21/50; B63B 21/00; B63B 35/44

(52) U.S. Cl. CPC B63B 21/50; B63B 35/44; B63B 2021/005; B63B 2035/446

(57) ABSTRACT

The invention concerns a mooring line for a floating platform, preferably a floating wind turbine platform, the mooring line comprising:
a first segment able to be attached to the platform;
a second segment able to be attached to a sea ground;
at least an intermediate segment formed of an elastomeric material and arranged between the first segment and the second segment.

The intermediate segment is able to provide a maximal extension greater than 100% of the rest length of the intermediate segment, advantageously a maximal extension greater than 300%.

The intermediate segment presents a minimal breaking strength greater than 18 MPa, advantageously greater than 25 MPa.

### CROSS REFERENCE TO RELATED APPLICATION

The present application is a U.S. National Phase application under 35 U.S.C. § 371 of International Patent Application No. PCT/EP2022/076549 filed Sep. 23, 2022, which claims priority of European Patent Application No. 21306324.1 filed Sep. 24, 2021. The entire contents of which are hereby incorporated by reference.

### FIELD OF THE INVENTION

The present invention concerns a mooring line for a floating platform.

The invention also concerns a floating platform comprising such a mooring line.

### BACKGROUND

In particular, the floating platform is a floating wind turbine platform.

A floating wind turbine platform needs to be moored on the sea ground. Mooring a floating wind turbine platform is challenging due to the combination of shallow water and severe environmental conditions which makes all this system quite dynamic with large tension peaks.

This implies that the mooring line must be quite long with respect to the water depth to provide the required softness in the system to maintain the line tension within acceptable level. With typical mooring system the line can be more than ten times longer than the water depth in shallow water and harsh conditions, which results in high mooring costs.

In order to reduce these costs, there is therefore a need to provide a mooring line having a reduced line length while maintaining or even reducing the extreme tension applied on this line.

Some known systems have been proposed to address this issue by providing elasticity in the mooring lines but none of them are deemed to be satisfactory.

For example, mechanical components using stainless steel have been proposed but it raises questions about the integrity of the system over twenty years of the service life in sea water and their cost effectiveness.

U.S. Pat. No. 9,308,969 B2 and EP 3 419 890 B1 describe for example mooring lines for a floating platform.

Others systems as for example described in documents EP 3129277 B1 or EP 2526014 B1 are deemed too complex, not cost effective enough or not resistant enough to guarantee an integrity over twenty years of service life in sea water and very dynamic system.

One of the aims of the present invention is therefore to provide a mooring line having a reduced mooring line length and a reduced extreme tension while allowing a satisfactory service life and significant mooring cost reduction.

### SUMMARY

For this purpose, the invention relates to a mooring line for a floating wind turbine platform, the mooring line comprising: a first segment able to be attached to the platform; a second segment able to be attached to a sea ground; and at least an intermediate segment formed of an elastomeric material and arranged between the first segment and the second segment. The intermediate segment is able to provide a maximal extension greater than 100% of the rest length of the intermediate segment, advantageously a maximal extension greater than 250%, preferably a maximal extension greater than 300%. The intermediate segment presents a minimal breaking strength greater than 15 MPa, preferably greater than 18 MPa, advantageously greater than 25 MPa.

Using these features, the mooring line according to the invention enables to reduce significantly the mooring cost. Indeed, the use of the intermediate segment along the mooring line located in the water column will provide adequate elasticity to design a semi taut or even a taut mooring system in shallow water and severe environmental conditions. This elasticity is provided by the elastomeric material that elongates when subjected to tensile stress. It allows to limit the maximum tension supported by the mooring line while reducing significantly its length. In particular, the invention enables to provide a mooring line having a length less than six times the water depth in shallow water, and even advantageously 1.5 times the water depth in case of taut mooring configuration in shallow water and mooring costs reduction of nearly 40% is expected.

The mooring line according to the invention comprises one or more of the following features, taken solely, or according to any technical feasible combination:
the intermediate segment presents a minimal breaking load greater than 400 T, advantageously greater than 1200 T;
the intermediate segment presents a creep lower than 20%, advantageously lower than 10%;
the intermediate segment presents a cumulative length lower than 40 m, advantageously lower than 15 m;
the intermediate segment presents a diameter comprised between 30 cm and 250 cm, for example between 30 cm and 150 cm, preferably between 30 cm and 120 cm;
the intermediate segment is made of a single material;
the single material is chosen between: natural rubber; thermoplastic elastomer; polychloroprene and hydrogenated nitrile butadiene rubber;
the intermediate segment is a multi-stranded line;
the first segment and the second segment are composed of one or a combination of the following materials: a metal segment, notably a metal chain or a steel wire; a synthetic fiber rope, notably a synthetic polyester line or a nylon rope;
the mooring line comprises at least a clump weight arranged on the second segment;
the mooring line is devoid of an antifouling treatment;
the mooring line comprises an additional intermediate segment formed of an elastomeric material and arranged between the first segment and the second segment.

The invention further concerns an assembly comprising a floating wind turbine platform able to be placed on a body of water and at least one mooring line attached to the platform, advantageously three mooring lines, at least one mooring line being as described above.

The floating platform according to the invention comprises one or more of the following features:
the said at least one mooring line presents a length lower than six times the height of the body of water;
the said at least one mooring line comprises a resting part resting on the sea ground and a raised part away from the sea ground, the intermediate segment of the said at least one mooring line being arranged in the raised part.

### BRIEF DESCRIPTION OF THE DRAWINGS

The invention will be better understood, upon reading of the following description, given solely as an example, and made in reference to the appended drawings, in which:

FIG. 1 is a schematic view of a floating wind turbine platform moored to the sea ground by a mooring line according to the invention;

FIG. 2 is a partial view of the mooring line of FIG. 1; and

FIG. 3 is a schematic view of a floating wind turbine platform moored to the sea ground by another embodiment of the mooring line according to the invention.

### DETAILED DESCRIPTION

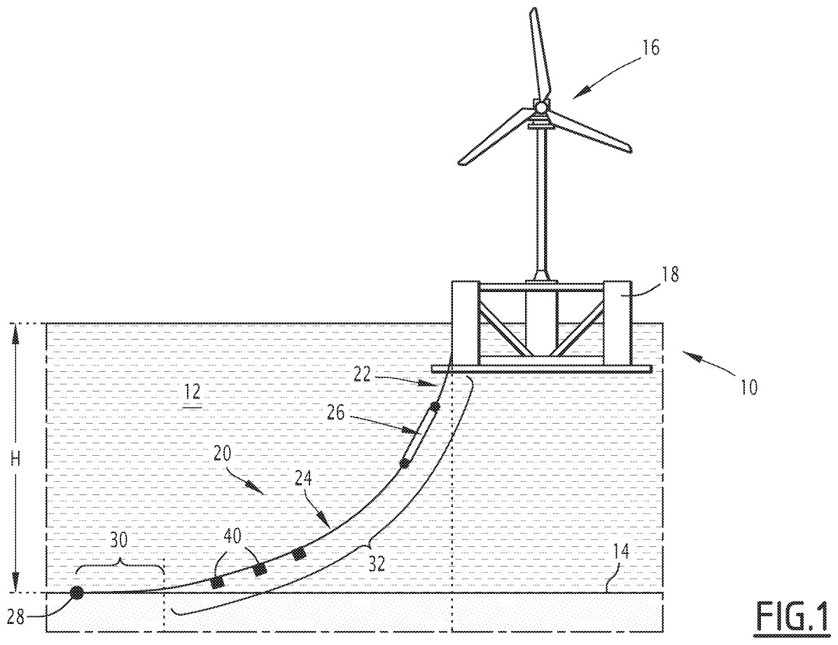

A floating platform is shown on FIG. 1.

The floating platform is here a floating wind turbine platform 10.

The following description is made in reference to the floating wind turbine 10, however the skilled person will understand that the invention may be applied to any floating platform.

The floating wind turbine platform 10 is able to be placed on a body of water 12.

In particular, the body of water 12 is for example a sea. The body of water 12 lies on a sea ground 14. The skilled person will understand that when the body of water 12 is a lake, the sea ground 14 is then the ground of the lake.

As visible in FIG. 1, the body water 12 presents a water depth H, according to a vertical direction, comprised between 50 m and 600 m, advantageously between 50 m and 200 m (for the purpose of the invention).

The floating wind turbine platform 10 is able to support a wind turbine 16.

When the floating wind turbine platform 10 is moored to the sea ground 14 on the operating site, the wind turbine 16 is configured to rotate in order to produce electricity.

On the example shown on the figures, the platform 10 comprises here three stabilizing columns 18 interconnected through beams. However, the floating wind turbine platform 10 may comprise three stabilizing columns 18, or more than three stabilizing columns 18. The floating wind turbine platform 10 may also be any floating system enabling to float on the body of water 12 and support the wind turbine 16.

The floating wind turbine platform 10 is attached to at least one mooring line.

Advantageously, the floating wind turbine platform 10 is attached to three mooring line. For example, a mooring line is attached to each stabilizing columns 18.

At least one of the mooring lines is a mooring line 20 according to the invention.

Advantageously, all the mooring lines are mooring lines 20 according to the invention.

Each mooring line 20 presents a length lower than six times the water height H of the body of water 12 in shallow water. By shallow water, it is understood having a water depth between 50 and 150 m.

The mooring lines 20 according to the invention are therefore shorter than conventional mooring line, in particular for an all chain conventional configuration, which typically presents a length greater than ten times the water height H to provide sufficient elasticity in mooring line 20 when the sea is rough in shallow water. This reduced length enables important mooring costs reduction.

For example, if the water height H is about 70 m high, a conventional mooring line would present a length of approximately 700 m in harsh ocean conditions whereas a mooring line 20 according to the invention presents a length lower than 400 m with equivalent, or even lower, extreme tensions.

Referring to the figures, the mooring line 20 comprises a first segment 22, a second segment 24 and at least one intermediate segment 26.

As visible on FIG. 1, the first segment 22 is able to be attached to the platform 10.

The second segment 24 is able to be attached to the sea ground 14, for example via an anchor 28.

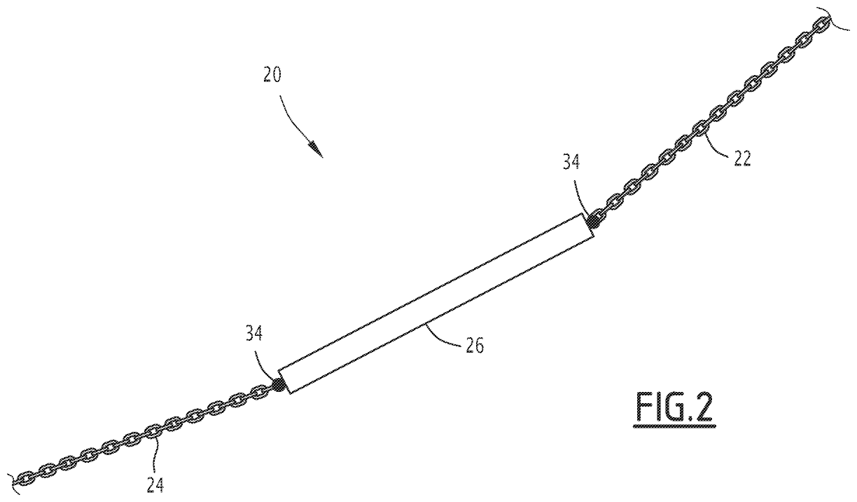

The first segment 22 and/or the second segment 24 are made of a metal segment, notably a steel wire or a metal chain as represented in FIG. 2.

In a variant, the first segment 22 and/or the second segment 24 are made of a synthetic fiber rope, notably a synthetic polyester line or a nylon rope.

In another variant, the first segment 22 and/or the second segment 24 may be composed of several sub-segments, each sub-segment being possibly made of a different material, as steel or polyester for example.

The first segment 22 and the second segment 24 present therefore a significant stiffness, notably greater than the stiffness of the intermediate segment 26.

On the example shown on the figures, each mooring line 20 comprises a resting part 30 resting on the sea ground 14 and a raised part 32 away from the sea ground 14.

However, in a variant, the mooring line 20 does not comprise a resting part on the sea ground 14, notably in case of taut mooring.

Each intermediate segment 26 is arranged in the raised part 32.

Each intermediate segment 26 is therefore away from the sea ground 14, avoiding abrasion of the intermediate segment 26 by contact with the sea ground 14.

The performance of the intermediate segment 26 is not impacted by its location in the raised part 32. However, the intermediate segment 26 is arranged preferably deep enough, notably lower than 20 m, to avoid UV exposure and to limit marine growth.

In the example shown on FIG. 1, the mooring line 20 comprises a unique intermediate segment 26.

The intermediate segment 26 extends along a longitudinal direction between two extremities.

The intermediate segment 26 is connected at a first extremity to the first segment 22 via an interface 34.

The intermediate segment 26 is connected at a second extremity, opposed to the first extremity to the second segment 24 via another interface 34.

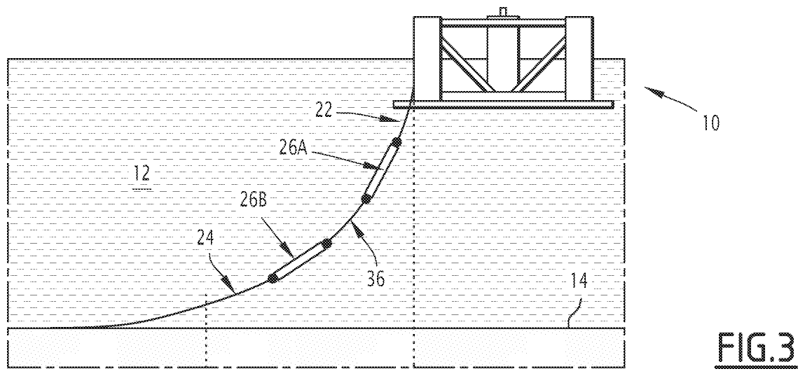

In the example shown on FIG. 3, the mooring line 20 comprises two intermediate segments 26A, 26B.

The first intermediate segment 26A is connected to the first segment 22 and the second intermediate segment 26B to the second segment 24.

A connecting segment 36 is arranged between the first intermediate segment 26A and the second intermediate segment 26B.

In a variant, the first intermediate segment 26A and the second intermediate segment 26B are connected directly, without the presence of a connection segment 36.

The connection segment 36 presents a similar structure to the first segment 22 and the second segment 24. In particular, the connection segment 36 is for example a metal segment or a synthetic fiber rope.

The skilled person will understand that, in a variant, the mooring line 20 may comprise more than two intermediate segments 26, for example three or four intermediate segments 26. A connection segment 36 is arranged between two intermediate segments 26.

Each intermediate segment 26 is formed of an elastomeric material.

In particular, the intermediate segment 26 is made of a single material.

Therefore, the intermediate segment 26 is devoid of other materials or mechanical pieces in addition to the elastomeric material. The intermediate segment 26 only comprises the elastomeric material arranged between the two interfaces 34.

The intermediate segment 26 is only able to respond to a single mode of solicitation, here a traction applied by the first and second segments 22, 24.

The intermediate segment 26 thus avoids having a strong non-linear elastic behavior under traction in which the stiffness of the intermediate segment 26 would increase when the traction force exerted thereon increases. Such strong non-linear behavior would result in high-tension peaks under extreme weather conditions, which would impair the integrity of the line itself.

The single material composing the intermediate segment 26 is chosen between: natural rubber; thermoplastic elastomer; polychloroprene and hydrogenated nitrile butadiene rubber.

Advantageously, each intermediate segment 26 is a multi-stranded line, comprising a plurality of strands extending between the two interfaces 34.

Preferably, the intermediate segment 26 comprises between 30 and 350 strands, for example between 30 and 150 strands, notably between 40 and 130 strands.

In particular, the intermediate segment 26 comprises about 100 strands of the elastomeric material.

In a preferred embodiment, the strands of the intermediate segment 26 run parallel to each other. Preferably, the strands are distributed symmetrically around a central axis of the intermediate segment 26.

Alternatively, the strands of the intermediate segment 26 are braided together.

The strands are made of the single material. Preferably, the strands are devoid of any metal.

Advantageously, all strands of the intermediate segment 26 have substantially the same length and/or thickness. Preferably, all strands of the intermediate segment 26 are identical to each other. The strands have thus substantially the same mechanical properties, notably the same maximal extension and minimal breaking strength.

For example, each strand has a substantially cylindrical shape, with a diameter comprised between 40 mm and 150 mm, preferably between 60 mm and 120 mm, more notably between 80 mm and 100 mm.

For example, the strands are at least partially coated by a protective composition, for example against fouling.

Each intermediate segment 26 presents advantageously a cylindrical shape extending between the first segment 22 and the second segment 24.

For example, each intermediate segment 26 presents a substantially circular, oval or rectangular cross section. Other cross section shapes may be considered.

Advantageously, each intermediate segment 26 presents substantially a circular cylindrical shape.

Each intermediate segment 26 presents a cumulative length lower than 40 m, advantageously lower than 15 m.

Each intermediate segment 26 presents a diameter comprised between 30 cm and 250 cm, for example between 30 cm and 150 cm, preferably between 30 cm and 120 cm.

When the intermediate segment 26 does not have a substantially circular cross section, the diameter is to be understood as the diameter of a fictive circular cylinder encompassing the intermediate segment 26.

Each intermediate segment 26 is able to provide a maximal extension greater than 100% of the rest length of the intermediate segment 26, advantageously a maximal extension greater than 300%, even more advantageously greater than 500%.

Typically, each intermediate segment 26 presents a maximal elongation length greater than 10 m.

The elasticity of the intermediate segment 26 is provided by the elastomeric material that elongates when the mooring line 20 is subjected to a tensile stress. It allows to limit the maximum tension supported by the mooring line 20.

Each intermediate segment 26 presents a minimal breaking strength greater than 15 MPa, preferably greater than 18 MPa, advantageously greater than 25 MPa.

Each intermediate segment 26 presents a minimal breaking load greater than 400 T, advantageously greater than 1200 T.

The intermediate segment 26 presents a creep lower than 20%, advantageously lower than 10%.

The creep is the permanent elongation from its initial length due to stretching of the polymer. By initial length it is understood the length at the beginning of the service life, without load.

The mooring line 20 according to the invention is therefore able to support the severe tension applied to the mooring line 20 due to the severe environmental conditions. The intermediate segment 26 allows to have a significant elongation. This makes it possible to reduce the section of the stiffer parts of the mooring line 20, namely the first segment 22 and the second segment 24, to reduce also their length and thus to provide significant mooring costs reduction.

As visible on FIG. 1, each mooring line 20 advantageously comprising at least a clump weight 40 arranged on the second segment 24.

In a variant, the mooring line 20 is devoid of any clump weight 40, notably in case of taut mooring.

The clump weights 40 enable to add some weight to the second segment 24 increasing the catenary effect of the line. This enables to reduce the mean offset of the floating structure 10 by increasing the restoring force of the line till the clump weights are all lifted. The other advantage of the clump weights is the reduction of the vertical load at the anchor location should drag embedment anchor be used.

The mooring line 20 is advantageously devoid of an antifouling treatment.

In conventional mooring lines, marine growth is not treated. In deep water, polyester rope is conventionally located deeper along the line to avoid marine growth, for example lower than 150 m deep.

The mooring line 20 according to the invention enables to eliminate the need for antifouling treatment due to the large deformations of the intermediate segment 26 and due to the material used for the intermediate segment 26, preventing the aquatic organisms from themselves to the mooring line 20.

It appears clear that the invention has a number of advantages.

In particular, the invention enables to limit the maximum tension supported by the mooring line 20 while reducing its length. Indeed, the intermediate segment 26 in an elastomeric material provides the elasticity enabling the mooring line 20 to support the severe tensions applied to the mooring line 20 due to the severe environmental conditions.

In particular, the invention enables to provide a mooring line presenting a length lower than six times the water depth and mooring costs reduction of nearly 40% are expected.

Moreover, the invention enables to eliminate the need for antifouling treatment for the mooring line 20, enabling to further reduce the costs and simplify the manufacturing of the mooring line 20.

Finally, as the length of the mooring line 20 is reduced, the resting part 30 of the mooring line 20 which is resting on the sea ground 14 is also reduced enabling a reduced footprint of the mooring system on the surrounding marine environment.

1. A mooring line for a floating platform, preferably a floating wind turbine platform, the mooring line comprising:
a first segment able to be attached to the platform;
a second segment able to be attached to a sea ground;
at least an intermediate segment formed of an elastomeric material and arranged between the first segment and the second segment,
the intermediate segment being able to provide a maximal extension greater than 300% of the rest length of the intermediate segment;
the intermediate segment presenting a minimal breaking strength greater than 25 MPa,
wherein the intermediate segment is only able to respond to a single mode of solicitation, said mode being a traction applied by the first and second segments,
the intermediate segment being made of a single material.

2. The mooring line according to claim 1, wherein the intermediate segment presents a minimal breaking load greater than 400 t.

3. The mooring line according to claim 1, wherein the intermediate segment presents a creep lower than 20%.

4. The mooring line according to claim 1, wherein the intermediate segment presents a cumulative length lower than 40 m.

5. The mooring line according to claim 1, wherein the intermediate segment presents a diameter comprised between 30 cm and 250 cm.

6. The mooring line according to claim 1, wherein the single material is chosen between:
natural rubber;
thermoplastic elastomer;
polychloroprene; and
hydrogenated nitrile butadiene rubber.

7. The mooring line according to claim 1, wherein the intermediate segment is a multi-stranded line.

8. The mooring line according to claim 1, wherein the first segment and the second segment are composed of one or a combination of the following materials:
a metal segment;
a synthetic fiber rope.

9. The mooring line according to claim 1, comprising at least a clump weight arranged on the second segment.

10. The mooring line according to claim 1, wherein the mooring line is devoid of an antifouling treatment.

11. The mooring line according to claim 1, comprising an additional intermediate segment formed of an elastomeric material and arranged between the first segment and the second segment.

12. An assembly comprising a floating platform, preferably a floating wind turbine platform, able to be placed on a body of water and at least one mooring line attached to the platform according to claim 1.

13. The assembly according to claim 12, wherein the said at least one mooring line presents a length lower than six times the height of the body of water.

14. The assembly according to claim 12, wherein the said at least one mooring line comprises a raised part away from the sea ground, the intermediate segment of the said at least one mooring line being arranged in the raised part.
